(19) United States
(12) Patent Application Publication
(10) Pub. No.: US 2022/0207348 A1
(43) Pub. Date: Jun. 30, 2022

(54) REAL-TIME NEURAL NETWORK RETRAINING

(71) Applicant: Ford Global Technologies, LLC, Dearborn, MI (US)

(72) Inventors: Sara Dadras, Redwood City, CA (US); Jinesh Jain, Pacifica, CA (US); Shreyasha Paudel, Sunnyvale, CA (US)

(73) Assignee: Ford Global Technologies, LLC, Dearborn, MI (US)

(21) Appl. No.: 17/136,565

(22) Filed: Dec. 29, 2020

(51) Int. Cl. G06N 3/08; G06N 3/04; G06N 20/10; B60W 50/00; B60W 10/04; B60W 10/18; B60W 10/20

(52) U.S. Cl. CPC G06N 3/08; G05D 1/0088; G06N 20/10; B60W 50/00; B60W 10/04; B60W 10/18; B60W 10/20; B60W 2050/0083; B60W 2710/18; B60W 2710/20; B60W 2556/45; B60W 2050/0077; B60W 2720/106; B60W 2720/125; B60W 2552/40; G06N 3/04

(57) ABSTRACT

A system comprising a computer including a processor and a memory, the memory including instructions such that the processor is programmed to: determine whether a difference between a friction coefficient label and a determined friction coefficient corresponding to an image depicting a surface is greater than a label threshold; modify the determined friction coefficient to equal the friction coefficient label when the difference is greater than the label threshold; and retrain a neural network using the image and the friction coefficient label.

### BACKGROUND

Deep neural networks (DNNs) can be used to perform many image understanding tasks, including classification, segmentation, and captioning. For example, convolutional neural networks can take an image as input, assign an importance to various aspects/objects depicted within the image, and differentiate the aspects/objects from one another.

### BRIEF DESCRIPTION OF THE DRAWINGS

FIG. 1 is a diagram of an example system including a vehicle.

FIG. 2 is a diagram of an example server within the system.

FIG. 3 is a diagram of an example deep neural network.

FIG. 4 is a diagram of an example neural network retraining system.

FIG. 5 is a flow diagram illustrating an example process for determining whether to modify a determined friction coefficient with a friction coefficient label.

### DETAILED DESCRIPTION

Autonomous vehicles typically employ perception algorithms to perceive the environment around the vehicle. The perception algorithms can use one or more deep neural networks to assist in classifying objects. For example, a deep neural network can be trained to input image data from a vehicle sensor configured to acquire images of a roadway ahead of the vehicle and determine an estimated coefficient of friction for the roadway. A computing device in the vehicle can use the estimated coefficient of friction to make decisions regarding control of vehicle powertrain, braking, and steering components. For example, the computing device can reduce limits on permitted lateral and longitudinal acceleration when a determined coefficient of friction for a roadway ahead of the vehicle indicate an increased probability of skidding. Other applications of deep neural networks include determining labels and locations for objects such as vehicles and pedestrians in an environment around a vehicle and determining real world location, speed and direction for the vehicle based on processing a sequence of video frames.

Training a deep neural network to process image data input and determine output data such as an estimated coefficient of friction for a roadway can require a training database that includes thousands of images. The training database can also require ground truth data corresponding to the training images. Ground truth data is data corresponding to the correct answer to be output by the deep neural network obtained by means independent from the deep neural network. For example, a vehicle can be instrumented to acquire data regarding wheel rotation and forward motion. Braking can be applied and the rate of wheel rotation compared to the forward motion to determine wheel slippage. A coefficient of friction for the roadway can be estimated based on the wheel slippage, for example. The training dataset should include image data that corresponds to the real world environments and appearances of roadway surfaces expected to be encountered when operating the vehicle. Acquiring thousands of training images and corresponding ground truth data can be very expensive and very time consuming. A large amount of work can be required to acquire the ground truth data and a large amount of computing resources can be required to train the deep neural network using a large training dataset.

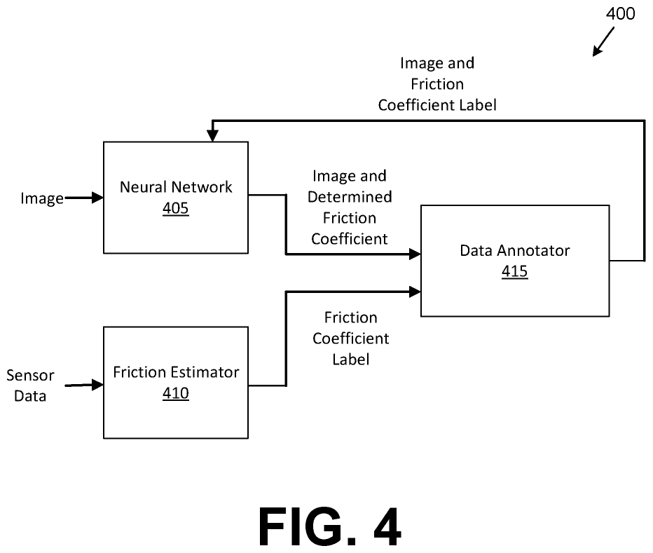

Techniques discussed herein can improve the training of deep neural networks by determining when a trained deep neural network acquires an input image that corresponds to a previously unseen coefficient of friction scenario. A previously unseen coefficient of friction scenario means that the appearance of the roadway in the image is not similar enough to the images in the training dataset to permit the deep neural network to determine an estimated coefficient of friction with a high probability of being correct. Coefficients of friction are determined to be similar when they are within an empirically determined label threshold. Determination of the coefficient of friction threshold is discussed in relation to FIG. 4, below. When the deep neural network determines that an input image is not similar to any images in the training database, a friction coefficient can be input from other vehicle sensors and used to re-train the deep neural network. The deep neural network can also be retrained when an output coefficient of friction differs from a coefficient of friction determined by other vehicle sensors. The re-trained deep neural network can be uploaded to a cloud-based server and shared with other vehicles.

Techniques discussed herein can be used to re-train deep neural networks for applications other than coefficient of friction determination. Any application that can obtain ground truth data independently from the deep neural network can be used to re-train a deep neural network. For example, a deep neural network can be trained to detect and locate other vehicles in the field of view of a vehicle based on image sensor data. Ground truth data regarding the location of other vehicles can be obtained from vehicle-to-vehicle communications or from infrastructure-to-vehicle communications and used to verify that the deep neural network is correctly identifying and locating vehicles.

A system comprising a computer including a processor and a memory, the memory including instructions such that the processor is programmed to: determine whether a difference between a friction coefficient label and a determined friction coefficient corresponding to an image depicting a surface is greater than a label threshold; modify the determined friction coefficient to equal the friction coefficient label when the difference is greater than the label threshold; and retrain a neural network using the image and the friction coefficient label.

In other features, the processor is further programmed to operate a vehicle based on the determined friction coefficient by controlling one or more of vehicle brakes, vehicle powertrain, and vehicle steering.

In other features, the processor is further programmed to operate the vehicle based on the determined friction coefficient includes reducing permitted lateral and longitudinal accelerations.

In other features, the processor is further programmed to determine the friction coefficient label based on vehicle sensor data.

In other features, the processor is further programmed to access a lookup table that correlates the vehicle sensor data to the friction coefficient label.

In other features, the vehicle sensor data comprises non-image sensor data.

In other features, the vehicle sensor data comprises at least one of data indicative of a wheel speed, tire rolling radius, wheel inertia, drive torque, brake torque, tire rolling resistance force, or longitudinal force.

In other features, the processor is further programmed to determine the friction coefficient via the neural network.

In other features, the processor is further programmed to: receive the image at the neural network; and determine the friction coefficient based on the image.

In other features, the neural network comprises a convolutional neural network.

In other features, the neural network comprises a support vector machine (SVM).

In other features, the neural network is retrained in real-time or near-real-time.

In other features, the neural network is retrained when a vehicle is operational.

In other features, the neural network determines a label for the surface in the image. A method comprises determining whether a difference between a friction coefficient label and a determined friction coefficient corresponding to an image depicting a surface is greater than a label threshold; modifying the determined friction coefficient to equal the friction coefficient label when the difference is greater than the label threshold; and retraining a neural network using the image and the friction coefficient label.

In other features, the method comprises determining the friction coefficient label based on vehicle sensor data.

In other features, the method comprises accessing a lookup table that correlates the vehicle sensor data to the friction coefficient label.

In other features, the vehicle sensor data comprises non-image sensor data.

In other features, the vehicle sensor data comprises at least one of data indicative of a wheel speed, tire rolling radius, wheel inertia, drive torque, brake torque, tire rolling resistance force, or longitudinal force.

In other features, the method comprises determining the friction coefficient via the neural network.

In other features, the method comprises: receiving the image at the neural network; and determining the friction coefficient based on the image.

In other features, the neural network comprises a convolutional neural network.

In other features, the neural network comprises a support vector machine (SVM).

In other features, the neural network is retrained in real-time or near-real-time.

In other features, the neural network is retrained when a vehicle is operational.

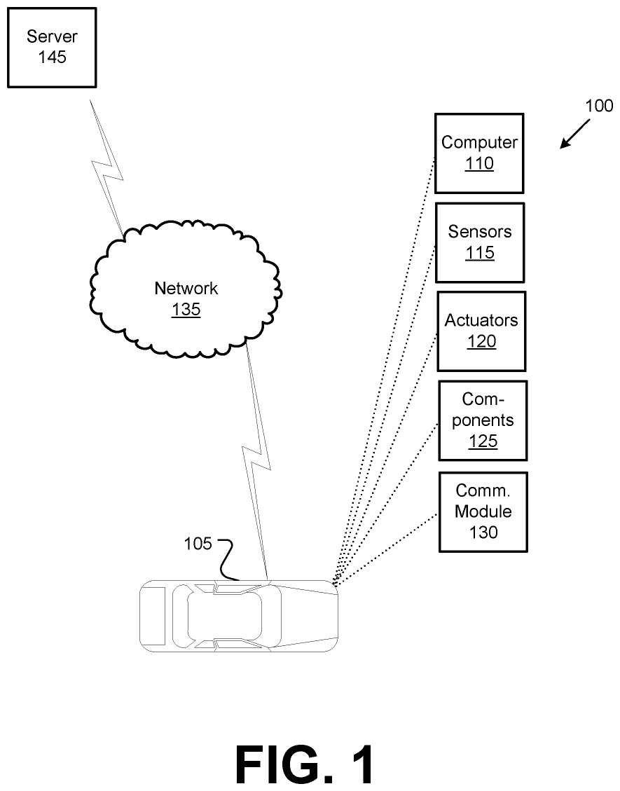

FIG. 1 is a block diagram of an example vehicle system 100. The system 100 includes a vehicle 105, which is a land vehicle such as a car, truck, etc. The vehicle 105 includes a computer 110, vehicle sensors 115, actuators 120 to actuate various vehicle components 125, and a vehicle communications module 130. Via a network 135, the communications module 130 allows the computer 110 to communicate with a server 145.

The computer 110 includes a processor and a memory. The memory includes one or more forms of computer-readable media, and stores instructions executable by the computer 110 for performing various operations, including as disclosed herein.

The computer 110 may operate and/or monitor a vehicle 105 in an autonomous, a semi-autonomous mode, or a non-autonomous (manual) mode i.e., can control and/or monitor operation of the vehicle 105, including controlling and/or monitoring components 125. For purposes of this disclosure, an autonomous mode is defined as one in which each of vehicle 105 propulsion, braking, and steering are controlled by the computer 110; in a semi-autonomous mode the computer 110 controls one or two of vehicles 105 propulsion, braking, and steering; in a non-autonomous mode a human operator controls each of vehicle 105 propulsion, braking, and steering.

The computer 110 may include programming to operate one or more of vehicle 105 brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations. Additionally, the computer 110 may be programmed to determine whether and when a human operator is to control such operations.

The computer 110 may include or be communicatively coupled to, e.g., via the vehicle 105 communications module 130 as described further below, more than one processor, e.g., included in electronic controller units (ECUs) or the like included in the vehicle 105 for monitoring and/or controlling various vehicle components 125, e.g., a powertrain controller, a brake controller, a steering controller, etc. Further, the computer 110 may communicate, via the vehicle 105 communications module 130, with a navigation system that uses the Global Position System (GPS). As an example, the computer 110 may request and receive location data of the vehicle 105. The location data may be in a known form, e.g., geo-coordinates (latitudinal and longitudinal coordinates).

The computer 110 is generally arranged for communications on the vehicle 105 communications module 130 and also with a vehicle 105 internal wired and/or wireless network, e.g., a bus or the like in the vehicle 105 such as a controller area network (CAN) or the like, and/or other wired and/or wireless mechanisms.

Via the vehicle 105 communications network, the computer 110 may transmit messages to various devices in the vehicle 105 and/or receive messages from the various devices, e.g., vehicle sensors 115, actuators 120, vehicle components 125, a human machine interface (HMI), etc. Alternatively or additionally, in cases where the computer 110 actually comprises a plurality of devices, the vehicle 105 communications network may be used for communications between devices represented as the computer 110 in this disclosure. Further, as mentioned below, various controllers and/or vehicle sensors 115 may provide data to the computer 110.

Vehicle sensors 115 may include a variety of devices such as are known to provide data to the computer 110. For example, the vehicle sensors 115 may include Light Detection and Ranging (lidar) sensor(s) 115, etc., disposed on a top of the vehicle 105, behind a vehicle 105 front windshield, around the vehicle 105, etc., that provide relative locations, sizes, and shapes of objects and/or conditions surrounding the vehicle 105. As another example, one or more radar sensors 115 fixed to vehicle 105 bumpers may provide data to provide and range velocity of objects (possibly including second vehicles), etc., relative to the location of the vehicle 105. The vehicle sensors 115 may further include camera sensor(s) 115, e.g. front view, side view, rear view, etc., providing images from a field of view inside and/or outside the vehicle 105.

The vehicle 105 actuators 120 are implemented via circuits, chips, motors, or other electronic and or mechanical components that can actuate various vehicle subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a brake component (as described below), a park assist component, an adaptive cruise control component, an adaptive steering component, a movable seat, etc.

In addition, the computer 110 may be configured for communicating via a vehicle-to-vehicle communication module 130 with devices outside of the vehicle 105, e.g., through a vehicle-to-vehicle (V2V) or vehicle-to-infrastructure (V2X) wireless communications to another vehicle, to (typically via the network 135) a remote server 145. The module 130 could include one or more mechanisms by which the computer 110 may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the module 130 include cellular, Bluetooth®, IEEE 802.11, dedicated short range communications (DSRC), and/or wide area networks (WAN), including the Internet, providing data communication services.

The network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, Bluetooth Low Energy (BLE), IEEE 802.11, vehicle-to-vehicle (V2V) such as Dedicated Short-Range Communications (DSRC), etc.), local area networks (LAN) and/or wide area networks (WAN), including the Internet, providing data communication services.

A computer 110 can receive and analyze data from sensors 115 substantially continuously, periodically, and/or when instructed by a server 145, etc. Further, friction estimation techniques can be used, e.g., in a computer 110 based on lidar sensor 115, camera sensor 115, etc., data, to identify a type of object, e.g., vehicle, person, rock, pothole, bicycle, motorcycle, etc., as well as physical features of objects.

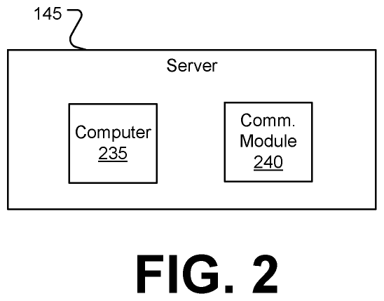

FIG. 2 is a block diagram of an example server 145. The server 145 includes a computer 235 and a communications module 240. The computer 235 includes a processor and a memory. The memory includes one or more forms of computer-readable media, and stores instructions executable by the computer 235 for performing various operations, including as disclosed herein. The communications module 240 allows the computer 235 to communicate with other devices, such as the vehicle 105.

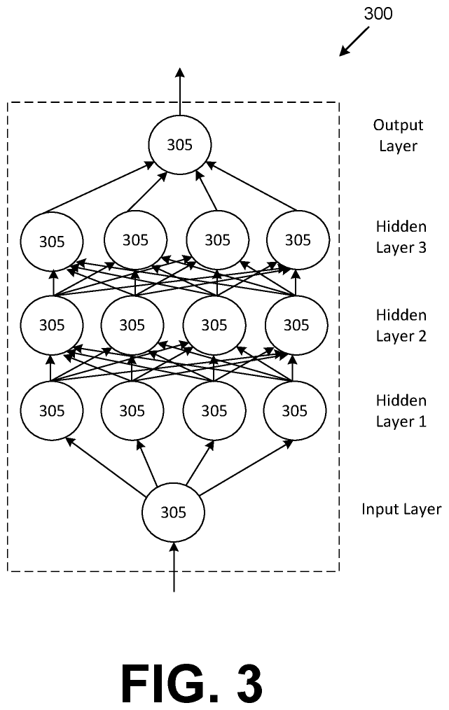

FIG. 3 is a diagram of an example deep neural network (DNN) 300. The DNN 300 may be representative of one or more neural networks described herein. The DNN 300 includes multiple nodes 305, and the nodes 305 are arranged so that the DNN 300 includes an input layer, one or more hidden layers, and an output layer. Each layer of the DNN 300 can include a plurality of nodes 305. While FIG. 3 illustrates three (3) hidden layers, it is understood that the DNN 300 can include additional or fewer hidden layers. The input and output layers may also include more than one (1) node 305.

The nodes 305 are sometimes referred to as artificial neurons, because they are designed to emulate biological, e.g., human, neurons. A set of inputs (represented by the arrows) to each node 305 are each multiplied by respective weights. The weighted inputs can then be summed in an input function to provide, possibly adjusted by a bias, a net input. The net input can then be provided to activation function, which in turn provides a connected node 305 an output. The activation function can be a variety of suitable functions, typically selected based on empirical analysis. As illustrated by the arrows in FIG. 3, node 305 outputs can then be provided for inclusion in a set of inputs to one or more nodes 305 in a next layer.

The DNN 300 can be trained to accept data as input and generate an output based on the input. The DNN 300 can be trained with ground truth data, i.e., data about a real-world condition or state. For example, the DNN 300 can be trained with ground truth data or updated with additional data by a processor. Weights can be initialized by using a Gaussian distribution, for example, and a bias for each node 305 can be set to zero. Training the DNN 300 can including updating weights and biases via suitable techniques such as backpropagation with optimizations. Ground truth data can include, but is not limited to, data specifying a friction coefficient corresponding to a surface depicted in an image. For example, the ground truth data may be data regarding surface friction coefficients corresponding to surface labels and data regarding labeling surfaces in images.

Back-propagation is a technique that returns outputs from the DNN 300 to the input to be compared to ground truth corresponding to testing data. In this example, during training, a label and an obstruction probability can be back-propagated to be compared to the label and the obstruction probability included in the ground truth to determine a loss function. The loss function determines how accurately the DNN 300 has processed the DNN 300. The DNN 300 can be executed a plurality of times on foreground and background data while varying parameters that control the processing of the DNN 300. Parameters that correspond to correct answers as confirmed by a loss function that compares the outputs to the ground truth are saved as candidate parameters. Following the test runs, the candidate parameters that produce the most correct results are saved as the parameters that can be used to program the DNN 300 during operation. Ground truth data can include, but is not limited to, data specifying a friction coefficient corresponding to a surface depicted in an image. The DNN 300 may be trained at the server 145 and provided to the vehicle 105 via the communication network 135.

FIG. 4 illustrates an example neural network retraining system 400 that includes a neural network 405, a friction estimator 410, and a data annotator 415. The neural network 405, the friction estimator 410, and the data annotator 415 can be stored in the computer 110 memory and executed by the computer 110 processor.

As discussed herein, the neural network 405 can be trained in real-time or near-real-time with data not previously seen. In some implementations, the neural network 405 is retrained with data while the vehicle 105 is operational. Initially, the neural network 405 can be trained using images labeled with a friction coefficient. A friction coefficient is the amount of friction between one or more of tires of the vehicle 105 and a surface on which the vehicle 105 travels. The friction coefficient may be static or kinetic and corresponds to the amount of force required to cause one or more tires of the vehicle 105 to skid or break traction. The neural network 405 may comprise a convolutional neural network (CNN), a support vector machine (SVM), a random decision forest regression neural network, or the like. The neural network 405 can initially be trained offline via the server 145 and deployed to the vehicle 105.

During operation, the neural network 405 can receive images from one or more sensors 115 and determines friction coefficients corresponding to a surface being traversed by the vehicle 105. The neural network 405 can provide the friction coefficients to the computer 110, and the computer 110 can determine one or more vehicle actions to perform based on the friction coefficients. For example, the computer 110 may alter a propulsion of the vehicle 105. In another example, the computer 110 may alter a vehicle path of the vehicle 105.

As discussed above, the neural network 405 determines a friction coefficient of the surface. In some implementations, the neural network 405 can use a correlation table generated during training that correlates images to friction-related data to train the neural network 405. The correlation table can include friction coefficients measured or estimated at the time the images are acquired. For example friction coefficients can be estimated by a human observer based on previously compiled tables that describe friction coefficients for various types of surfaces, i.e. dry pavement, pavement covered with ice, wet pavement, pavement with standing water, etc. The previously compiled tables can be determined by testing the various types of surfaces with vehicles to determine the amount of force required to cause a vehicle wheel to skid or lose traction. Friction coefficients can also be determined by estimating the friction coefficients using a friction estimator 410 that inputs data from sensors 115 included in a vehicle 105 and outputs an estimated friction coefficient.

The friction estimator 410 receives sensor 115 data, e.g., from one or more vehicle buses, and determines friction coefficient based on the sensor 115 data. In an example implementation, the sensor 115 data can be data indicative of a wheel speed, tire rolling radius, wheel inertia, drive torque, brake torque, tire rolling resistance force, longitudinal force, or the like. The friction estimator 410 can include a previously compiled table of friction coefficients as discussed above that correlates the sensor 115 data to a friction coefficient. In this example the previously compiled table would include friction coefficients determined by testing the amount of force required to make a vehicle tire skid correlated with sensor 115 data. For example, if the wheel rotation speed times the tire circumference is not equal to the speed of the vehicle 105, the tire must be skidding. The speed at which the tire begins to skid can be combined with the lateral and longitudinal accelerations to determine a coefficient of friction for the surface. The friction estimator 410 outputs friction coefficient labels corresponding to the received sensor 115 data.

The data annotator 415 receives the friction coefficient labels generated by the friction estimator 410 and the images and corresponding determined friction coefficients from the neural network 405. The data annotator 415 compares the friction coefficient labels generated by the friction estimator 410 and the determined friction coefficients from the neural network 405 to determine whether a difference exceeds a label threshold. For example, the data annotator 415 compares the determined friction coefficient corresponding to an image generated to a corresponding friction coefficient label generated by the friction estimator 410. The label threshold is a metric, e.g., an empirically determined metric determined during training of the neural network 405 that represents an allowable difference between the friction coefficient labels generated by the friction estimator 410 and the determined friction coefficients from the neural network 405. The label threshold can be determined by estimating a plurality of friction coefficients using a friction estimator 410 based on similar sensor 115 data and determining a standard deviation for the friction coefficient estimates. The label threshold can be determined as one standard deviation from the mean friction coefficient estimate, for example.

If the difference exceeds the label threshold, the data annotator 415 modifies the determined friction coefficients corresponding to the image to be equal to the friction coefficient label such that the image is labeled with the friction coefficient label. Thus, the image corresponds to the friction coefficient label generated by the friction estimator 410 and not the determined friction coefficient generated by the neural network 405. The data annotator 415 can determine which image corresponds to the friction coefficient label using timestamps. For example, the data annotator 415 can match an image to a friction coefficient label when a time stamp of the image is within a predetermined time range of a time stamp of the friction coefficient label. The data annotator 415 provides the image and the friction coefficient label to the neural network 405. After receiving the image and the friction coefficient label, the neural network 405 can enter a training phase in which the neural network 405 is retrained with the image and the friction coefficient label.

The friction coefficient corresponding to the image output by the neural network 405 can be used by a computer 110 to operate a vehicle 105 by transmitting signals to actuators 120 that control vehicle powertrain, steering, and brakes, for example. For example, neural network 405 can determine, based on an input image, that the roadway surface directly ahead of the vehicle 105 includes a reduced friction coefficient. The reduced friction coefficient can be due to water or ice on the roadway surface, for example. The computer 110 can operate a vehicle 105 by determining a vehicle path based on a path polynomial, i.e., one or more polynomial functions that describe a predicted path for the vehicle 105 to travel. The polynomial functions can be determined by calculating lateral and longitudinal accelerations to apply to the vehicle by controlling vehicle powertrain, steering and brakes. The lateral and longitudinal accelerations can include maximum limits based on accelerations that would cause skidding, or loss of traction between the vehicle's wheels and the roadway. When a reduced coefficient of friction is detected by neural network 405, computer 110 can reduce the maximum lateral and longitudinal accelerations permitted in determining the polynomial functions included in the vehicle path. Determining a coefficient of friction by processing images with a neural network 405 can improve operation of a vehicle 105 by reducing the permitted lateral and longitudinal accelerations and thereby reducing a tendency for the vehicle 105 to skid in reduced coefficient of friction conditions.

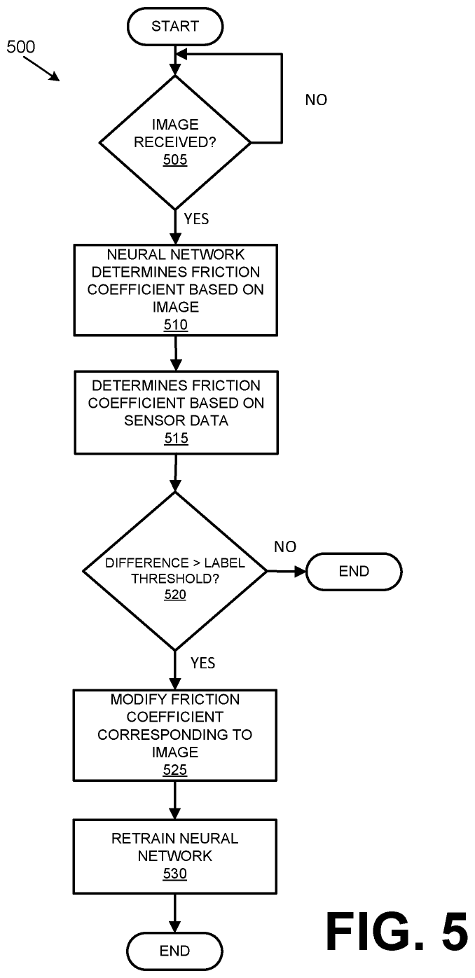

FIG. 5 is a flowchart illustrating an exemplary process 500 for determining whether to modify a determined friction coefficient generated by the neural network 405 with a friction coefficient label determined by the friction estimator 410. Blocks of the process 500 can be executed by the computer 110. The process 500 begins at block 505 in which a determination is made whether an image is received. The image includes one or more pixels representing an environment being traversed by the vehicle 105 captured by one or more sensors 115. If no image has been received, the process 500 returns to 505.

If the image has been received, the neural network 405 determines one or more friction coefficients corresponding to a surface being traversed by the vehicle 105 at block 510. As discussed above, the neural network 405 can apply one or more conventional convolutional neural network techniques to the image. The neural network 405 can correlate or apply a mathematical relationship to the convoluted image to a corresponding friction coefficient. At block 515, the friction estimator 410 determines a friction coefficient label based on sensor 115 data. In an example implementation, the friction estimator 410 can determine the friction coefficient label with non-image sensor 115 data, such as sensor 115 data received via one or more vehicle buses.

At block 520, the data annotator 415 determines whether a difference between the friction coefficient determined by the neural network 405 and the friction coefficient label generated by the friction estimator 410 exceeds a label threshold. If the difference does not exceed the label threshold, the process 500 ends. If the difference exceed the label threshold, the data annotator 415 modifies the friction coefficient corresponding to the image such the friction coefficient equals the friction coefficient label at block 525. The neural network 405 is retrained with the image and the friction coefficient label at block 530. In one or more implementations, the neural network 405 is retrained in real-time or near-real-time. In some implementations, the neural network 405 may be retrained once the vehicle 105 stops moving. The process 500 then ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system comprising a computer including a processor and a memory, the memory including instructions such that the processor is programmed to:
determine whether a difference between a friction coefficient label and a determined friction coefficient corresponding to an image depicting a surface is greater than a label threshold;
modify the determined friction coefficient to equal the friction coefficient label when the difference is greater than the label threshold; and
retrain a neural network using the image and the friction coefficient label.

2. The system of claim 1, wherein a vehicle is operated based on the determined friction coefficient by controlling one or more of vehicle brakes, vehicle powertrain, and vehicle steering.

3. The system of claim 2, wherein operating the vehicle based on the determined friction coefficient includes reducing permitted lateral and longitudinal accelerations.

4. The system of claim 1, wherein the processor is further programmed to determine the friction coefficient label based on vehicle sensor data.

5. The system of claim 4, wherein the processor is further programmed to access a lookup table that correlates the vehicle sensor data to the friction coefficient label.

6. The system of claim 4, wherein the vehicle sensor data comprises non-image sensor data.

7. The system of claim 4, wherein the vehicle sensor data comprises at least one of data indicative of a wheel speed, tire rolling radius, wheel inertia, drive torque, brake torque, tire rolling resistance force, or longitudinal force.

8. The system of claim 1, wherein the processor is further programmed to determine the friction coefficient via the neural network.

9. The system of claim 8, wherein the processor is further programmed to:
receive the image at the neural network; and
determine the friction coefficient based on the image.

10. The system of claim 8, wherein the neural network comprises a convolutional neural network.

11. The system of claim 8, wherein the neural network comprises a support vector machine (SVM).

12. The system of claim 1, wherein the neural network is retrained in real-time or near-real-time.

13. The system of claim 1, wherein the neural network is retrained when a vehicle is operational.

14. A method comprising:
determining whether a difference between a friction coefficient label and a determined friction coefficient corresponding to an image depicting a surface is greater than a label threshold;
modifying the determined friction coefficient to equal the friction coefficient label when the difference is greater than the label threshold; and
retraining a neural network using the image and the friction coefficient label.

15. The method of claim 14, wherein a vehicle is operated based on the determined friction coefficient by controlling one or more of vehicle brakes, vehicle powertrain, and vehicle steering.

16. The method of claim 15, wherein operating the vehicle based on the determined friction coefficient includes reducing permitted lateral and longitudinal accelerations.

17. The method of claim 14, further comprising determining the friction coefficient label based on vehicle sensor data.

18. The method of claim 17, further comprising accessing a lookup table that correlates the vehicle sensor data to the friction coefficient label.

19. The method of claim 17, wherein the vehicle sensor data comprises non-image sensor data.

20. The method of claim 17, wherein the vehicle sensor data comprises at least one of data indicative of a wheel speed, tire rolling radius, wheel inertia, drive torque, brake torque, tire rolling resistance force, or longitudinal force.
